(19) United States
(12) Patent Application Publication
(10) Pub. No.: US 2011/0294936 A1
(43) Pub. Date: Dec. 1, 2011

(54) TIRE TREAD RUBBER COMPOSITION AND PNEUMATIC TIRE USING THE SAME

(76) Inventor: Masaki Sato, Kanagawa (JP)

(21) Appl. No.: 13/116,440

(22) Filed: May 26, 2011

(30) Foreign Application Priority Data
May 28, 2010 (JP) 2010-122390

(51) Int. Cl. C08K 5/10

(52) U.S. Cl. 524/315

(57) ABSTRACT

A tire tread rubber composition includes: 100 parts by mass of diene rubber; 60 to 110 parts by mass of specific silica; and a mixture of a fatty acid metal salt (excluding zinc salt) and a fatty acid ester in which a mass ratio to the specific silica is 2 to 8 mass %, in which the diene rubber contains not less than 40 parts by mass of solution-polymerization SBR, the solution-polymerization SBR includes a weight-average molecular weight of 900,000 to 1,500,000 and a styrene content of 35 to 45%, and the specific silica satisfies the following conditions of (1) to (4): (1) N₂SA is 194 to 225 m²/g; (2) a CTAB specific surface area is 170 to 210 m²/g; (3) a ratio of the N₂SA/the CTAB specific surface area is 0.9 to 1.4; and (4) a DBP absorption is not less than 190 ml/100 g.

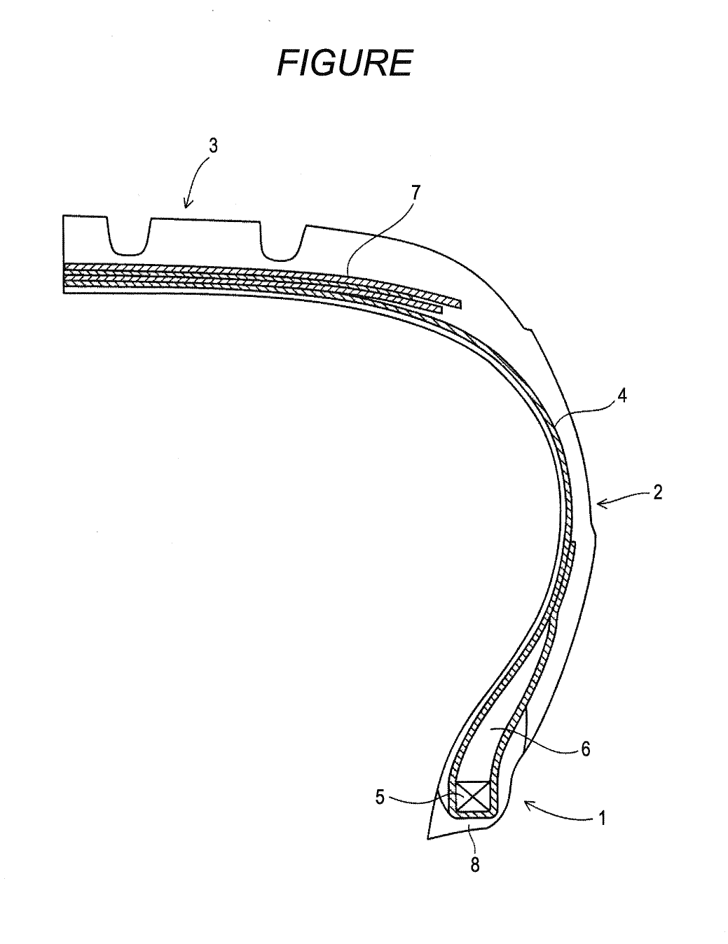

### CROSS-REFERENCE TO RELATED APPLICATION

This application is based on Japanese Patent Application No. 2010-122390 filed with the Japan Patent Office on May 28, 2010, the entire content of which is hereby incorporated by reference.

### BACKGROUND

1. Technical Field

One aspect of the present invention relates to a tire tread rubber composition and a pneumatic tire using the same. More particularly, one aspect of the present invention relates to a tire tread rubber composition that has a good vulcanization rate and excels at a wet grip performance and a fuel consumption performance, and relates also to a pneumatic tire using the same.

2. Related Art

It is desired that a pneumatic tire can demonstrate various types of performances. In particular, it is desired to offer an excellent balance between a wet grip performance and a fuel consumption performance. A known technology to improve these performances is to blend a tire tread rubber composition with silica.

In this technology, when silica of higher specific surface area is used, the number of bonds between the silica and the rubber increases. This improves the reinforcement by the silica and it is therefore presumed that the wet grip performance of the tire tread rubber composition is improved. However, as a result of study of the present inventors, a problem that occurs when the silica of higher specific surface area is used has been found. The problem is that since an interaction between the silicas increases, the dispersibility of the silicas deteriorates, as a result of which a desired effect cannot be obtained. Another problem is that when a large amount of silica of higher specific surface area is blended, a vulcanizing accelerator is adsorbed into the silica, which slows the vulcanization rate of the tire tread rubber composition. It is noted that the silica of higher specific surface area is disclosed in JP-T-2005-500238.

An object of one aspect of the present invention is to provide a tire tread rubber composition having, in spite of the inclusion of silica of higher specific surface area, a good dispersion state of silica and a good vulcanization rate and excelling at a wet grip performance and a fuel consumption performance, and to provide a pneumatic tire using the same.

### SUMMARY

As a result of undertaking earnest study, the present inventors could have achieved one aspect of the present invention. The technology is to blend a specific amount of silica having a specific property and a higher specific surface area and a specific amount of a specific mixture, with a specific diene rubber. The specific diene rubber is rubber containing a specific amount of styrene-butadiene copolymer rubber having a specific molecular weight and styrene content. Further, the specific mixture is a mixture of a fatty acid metal salt and a fatty acid ester.

That is, the tire tread rubber composition according to one aspect of the present invention includes:

100 parts by mass of diene rubber;

60 to 110 parts by mass of specific silica; and

a mixture of a fatty acid metal salt (excluding zinc salt) and a fatty acid ester in which a mass ratio relative to the specific silica is 2 to 8 mass %, in which

the diene rubber contains not less than 40 parts by mass of solution-polymerization styrene-butadiene copolymer rubber,

the solution-polymerization styrene-butadiene copolymer rubber includes a weight-average molecular weight of 900,000 to 1,500,000 and a styrene content of 35 to 45%, and

the specific silica satisfies the following conditions of (1) to (4):

(1) a nitrogen adsorption specific surface area (N₂SA) evaluated in accordance with JIS K6217-2 is 194 to 225 m²/g;

(2) a CTAB specific surface area evaluated in accordance with JIS K6217-3 is 170 to 210 m²/g;

(3) a ratio between the nitrogen adsorption specific surface area (N₂SA) and the CTAB specific surface area (the nitrogen adsorption specific surface area (N₂SA)/the CTAB specific surface area) is 0.9 to 1.4; and

(4) a DBP absorption evaluated in accordance with oil absorption method A of JIS K6217-4 is not less than 190 ml/100 g.

### BRIEF DESCRIPTION OF THE DRAWINGS

The foregoing and other objects, features, aspects and advantages of the invention will become more apparent from the following detailed description when taken in conjunction with the accompanying drawings, in which:

FIGURE is a partial cross-sectional view of one example of a pneumatic tire.

### DESCRIPTION OF EMBODIMENTS

Preferred embodiments of the present invention will be described below with reference to the accompanying drawings, in which like reference characters designate similar or identical parts throughout the several views thereof.

Hereinafter, an embodiment of the present invention will be described in detail.

FIGURE is a partial cross-sectional view of one example of a pneumatic tire for an automobile, according to the present embodiment.

This pneumatic tire includes a pair of right and left bead portions 1 and side walls 2. The pneumatic tire further includes: a tread 3 communicated to the both side walls 2; and a carcass layer 4.

The bead portion 1 includes a bead core 5, a bead filler 6, and a rim cushion 8. The rim cushion 8 is disposed in a portion making contact with a rim.

The carcass layer 4 is laid between the bead portions 1. A fiber cord is embedded in the carcass layer 4. The end of the carcass layer 4 is wound up to be folded from inside the tire to the outside so that the bead core 5 and the bead filler 6 are surrounded.

The tread 3 includes a belt layer 7. The belt layer 7 is disposed over the entire circumference of the tire outside the carcass layer 4.

A rubber composition (the present rubber composition) according to the present embodiment, which will be described below, is a tire tread rubber composition particularly useful for the tread 3.

The rubber composition contains diene rubber, silica, a mixture of a fatty acid metal salt and a fatty acid ester, and a filler. These components have characteristics described below. This makes it possible for the rubber composition to demonstrate effects that a good dispersion state of silica and a good vulcanization rate are achieved, and as a result, a good wet grip performance and fuel consumption performance can be obtained.

### (Diene Rubber)

The diene rubber used in the rubber composition contains specific solution-polymerization styrene-butadiene copolymer rubber (hereinafter, may be referred to as “specific SBR”). The specific SBR includes a weight-average molecular weight of 900,000 to 1,500,000 and a styrene content of 35 to 45%. It is preferable that the specific SBR occupies not less than 40 parts by mass per 100 parts by mass of the diene rubber. When the weight-average molecular weight and the styrene content of the specific SBR are within the above-described range, it is possible to impart the silica with the optimal shear stress during a kneading step. This improves the dispersibility of silica. When the weight-average molecular weight of the specific SBR is less than 900,000, the shear stress during the kneading step deteriorates. Thus, the dispersibility of silica deteriorates. On the other hand, when the weight-average molecular weight of the specific SBR exceeds 1,500,000, the viscosity of the rubber itself becomes too high. Thus, a processability during kneading deteriorates. In particular, it is preferable that the specific SBR has a vinyl content arising from butadiene of not more than 45%. A reason why the specific SBR should have not less than 40 parts by mass is to obtain the above-described effects of the rubber composition.

The specific SBR is commercially available. Examples of the commercially available specific SBRs include: BUNA VSL 2438-2 HM manufactured by LANXESS K.K. Corporation (weight-average molecular weight=1,290,000, styrene content=41%, and the above-described vinyl content=38%), and SLR6430 (product name) manufactured by The Dow Chemical Company (weight-average molecular weight=1,010,000, styrene content=41%, and the above-described vinyl content=25%).

In addition to the above-described specific SBR, other rubbers may be blended with the diene rubber. Examples of the other rubbers include natural rubber (NR), isoprene rubber (IR), butadiene rubber (BR), and acrylonitrile-butadiene copolymer rubber (NBR). The other rubbers may be used singly, or two or more kinds thereof may be used in combination. There is no particular restriction on a molecular weight or a micro structure of the other rubbers. The other rubbers may be chain-end-modified or epoxidized by amine, amide, silyl, alkoxysilyl, carboxyl, and a hydroxyl group, for example.

As the other rubbers, BR is preferably used. This use is to obtain the above-described effects of the rubber composition.

### (Silica)

The silica used in the rubber composition (hereinafter, may be referred to as “specific silica”) satisfies the following conditions (1) to (4):

(1) a nitrogen adsorption specific surface area (N₂SA) evaluated in accordance with JIS K6217-2 is 194 to 225 m²/g;

(2) a CTAB specific surface area evaluated in accordance with JIS K6217-3 is 170 to 210 m²/g;

(3) a ratio between the nitrogen adsorption specific surface area (N₂SA) and the CTAB specific surface area (the nitrogen adsorption specific surface area (N₂SA)/the CTAB specific surface area) is 0.9 to 1.4; and

(4) a DBP absorption evaluated in accordance with oil absorption method A of JIS K6217-4 is not less than 190 ml/100 g.

It is preferable that in order to obtain the above-described effects of the rubber composition, the silica that satisfies all of the above-described requirements (1) to (4) is used.

More preferable properties of the specific silica are provided below:

(5) a nitrogen adsorption specific surface area (N₂SA) evaluated in accordance with JIS K6217-2 is 200 to 225 m²/g;

(6) a CTAB specific surface area evaluated in accordance with JIS K6217-3 is 180 to 210 m²/g;

(7) a ratio between the nitrogen adsorption specific surface area (N₂SA) and the CTAB specific surface area (nitrogen adsorption specific surface area (N₂SA)/CTAB specific surface area) is 1.0 to 1.3; and

(8) a DBP absorption evaluated in accordance with oil absorption method A of JIS K6217-4 is 195 to 230 ml/100 g.

A method of manufacturing the specific silica that satisfies all of the conditions (1) to (4) is well known and disclosed in JP-T-2005-500238, for example. In the method described in this literature, a silicate is reacted with an acidifying agent to obtain a silica suspension. Subsequently, the suspension is separated and dried.

Then, in this method, the silica suspension, which is a reaction mixture between the silicate and the acidifying agent, is obtained according to continuous steps, described below, of:

(i) forming an aqueous stock having a pH of between 2 and 5 (preferably, between 2.5 and 5);
(ii) simultaneously adding the silicate and the acidifying agent to the stock to form a reaction mixture, where the addition is implemented so that the pH of the reaction mixture is maintained between 2 and 5 (preferably, between 2.5 and 5);
(iii) after stopping the addition of the acidifying agent, continuing the addition of the silicate to the reaction mixture, where this addition is continued until the pH value of the reaction mixture reaches between 7 and 10 (preferably, between 7.5 and 9.5);
(iv) after the preceding step (iii), simultaneously adding the silicate and the acidifying agent to the reaction mixture, where the addition is implemented so that the pH of the reaction mixture is maintained between 7 and 10 (preferably, between 7.5 and 9.5); and
(v) after stopping the addition of the silicate, continuing the addition of the acidifying agent to the reaction mixture, where this addition is continued until a pH value of the reaction mixture reaches not more than 6.

As the specific silica, a commercially available silica can also be used. Examples thereof include Zeosil Premium 200 MP manufactured by Rhodia.

It is preferable that the specific silica has a size distribution width Ld((d84−d16)/d50) of at least 0.91 and a pore volume distribution ratio V(d5−d50)N(d5−d100) of at least 0.66. This facilitates obtaining the above-described effects of the rubber composition.

A method of measuring the size distribution width Ld((d84−d16)/d50) and the pore volume distribution ratio V(d5−d50)/V(d5−d100) is well known, and such a method is described in JP-T-2005-500238. Property values provided in the present embodiment are measured according to the method described in JP-T-2005-500238.

The size distribution width Ld((d84−d16)/d50) is measured by XDC particle size analysis using centrifugal sedimentation.

For this analysis, BI-XDC (Brookhaven Instruments X Disc Centrifuge) centrifugal sedimentation particle size analyzer sold by Brookhaven Instruments Corporation can be used.

A specimen applied to the analyzer is prepared as follows: A suspension is prepared by adding 3.2 g of silica and 40 ml deionized water to a tall-form beaker. Into this suspension, 1500-watt Branson probe (used at 60% of maximum power) is immersed. With this probe, the suspension is disintegrated for 20 minutes.

In a register of the analyzer, recorded are values of a diameter through which 16 weight %, 50 weight % (or median), and 84 weight % of particles pass. From these register values, the size distribution width Ld((d84−d16)/d50) is calculated. Here, dn is a size for which the diameter of n % (weight %) of particles per all the particles is smaller than dn. Therefore, the distribution width Ld is calculated from the cumulative particle size of all the particles.

The ratio V(d5−d50)N(d5−d100) is measured by mercury porosimetry. The specimen is prepared as follows: that is, silica is predried for two hours in an oven at 200° C. Subsequently, the dried silica is removed from the oven, and then, placed in a test container within five minutes. Then, a rotary vane pump, for example, is used to eliminate gas within the test container so that the interior is evacuated. The pore diameter is measured with AUTOPORE III 9420 Micromeritics porosimeter. That is, the pore diameter is calculated by substituting a contact angle of 140 degrees and a surface tension y of 484 dynes/cm (or N/m) into the Washburn equation.

V(d5−d50) denotes a pore volume formed by a pore having a diameter between d5 and d50. V(d5−d100) denotes a pore volume formed by a pore having a diameter between d5 and d100. Here, dn denotes a value so that a total surface area of a pore having a diameter larger than dn occupies n % of the area per a total surface area of all the pores. It is noted that the total surface area of all the pores (S₀) is determined from a mercury intrusion curve.

### (Mixture of Fatty Acid Metal Salt and Fatty Acid Ester)

The rubber composition contains a mixture of a fatty acid metal salt and a fatty acid ester.

Examples of the fatty acid to be used include a saturated or unsaturated fatty acid with a carbon number of 3 to 30. More specifically, examples thereof include lauric acid, myristic acid, palmitic acid, stearic acid, oleic acid, and linoleic acid.

A metal used for forming a salt of these fatty acids is at least one metal selected from K, Ca, Na, Mg, Co, Ni, Ba, Fe, Al, Cu, and Mn. In particular, it is preferable to use K and Ca. To obtain the above-described effects of the rubber composition, it is preferable not to use a zinc salt as the fatty acid metal salt.

Examples of an esterification product to be used include a lower alcohol with a carbon number of not more than 10.

The fatty acid metal salt and the fatty acid ester may be used as individual components or used in combination of two or more components.

### (Filler)

In addition to the above-described silica, various fillers can be blended with the rubber composition. There is no particular restriction on the filler that can be used. An appropriate filler may be selected according to a purpose. Examples of the filler that can be used include carbon black and inorganic filler. Examples of the inorganic filler include clay, talc, and calcium carbonate.

### (Blend Ratio of the Rubber Composition)

In the rubber composition, 60 to 110 parts by mass of specific silica relative to 100 parts by mass of diene rubber, and a mixture of the fatty acid metal salt (excluding zinc salt) and the fatty acid ester having a mass ratio of 2 to 8 mass % relative to the specific silica are blended.

When the blend ratio of the specific silica is less than 60 parts by mass, the addition amount is too small, and as a result, it is not easy to achieve the above-described effects of the rubber composition. Contrary, when the blend ratio exceeds 110 parts by mass, the fuel consumption performance of a tire deteriorates.

When the blend ratio of the mixture of the fatty acid metal salt and the fatty acid ester is less than 2 mass %, the mixture addition amount is too small, and as a result, it is not easy to achieve the above-described effects of the rubber composition. Contrary, when the blend ratio exceeds 8 mass %, the physical property of the rubber composition after vulcanization deteriorates.

A more preferable blend amount of the specific silica is 65 to 100 parts by mass relative to 100 parts by mass of diene rubber.

A more preferable blend amount of the mixture of the fatty acid metal salt and the fatty acid ester is 3 to 7 mass % relative to the specific silica.

In the rubber composition, in addition to the above-described components, various types of additives that are generally blended with a tire tread rubber composition, such as a vulcanizing or cross-linking agent, a vulcanizing or cross-linking accelerator, various types of oils, an antioxidant, and a plasticizing agent, can be blended. Such additives can be kneaded according to a general method to obtain a composition, which are used for vulcanization or cross-linkage. The blend amount of these additives may be a conventional general blend amount as long as the above-described effects of the rubber composition can be obtained.

The rubber composition can be used for manufacture of a pneumatic tire according to a conventional method of manufacturing a pneumatic tire.

### EXAMPLES

Hereinafter, the configuration and effect of the rubber composition will be described by using Examples and Comparative Examples. It is noted that the rubber composition is not limited to the below-described examples.

### Preparation of Examples 1 to 4 and Comparative Examples 1 to 7

In Examples and Comparative Examples, a sample of the tire tread rubber composition was manufactured. Table 1 shows a component and its blend amount (parts by mass) in Examples and Comparative Examples. The samples in Examples and Comparative Examples were manufactured as follows: that is, firstly, components other than a vulcanization system (vulcanizing accelerator and sulfur) were kneaded for five minutes using a 1.7-liter internal Banbury mixer. As a result, an unvulcanized rubber composition was obtained. Thereafter, the unvulcanized rubber composition was removed from the mixer and cooled at room temperature. Subsequently, the cooled unvulcanized rubber composition was placed inside the Banbury mixer again and kneaded, with a vulcanization system being added. Thereby, the samples of Examples and Comparative Examples were obtained.

The unvulcanized rubber compositions relating to the respective Examples and Comparative Examples were subjected to each of measurement tests described below. The results are shown in Table 1.

Measurement of a vulcanization rate: a vulcanization time (T30) of the resultant unvulcanized rubber composition was measured in accordance with JIS K6300-2. In this measurement, a rotorless vulcameter was used to evaluate a vulcanization curve indicating a relationship between a torque obtained at a temperature of 160° C. and a vulcanization time. Then, a vulcanization time (T30) required until 30% the maximum torque was reached was measured. In Table 1, the vulcanization rate is a relative value when a value of Comparative Example 1 is indexed at 100. The larger the index, the faster the vulcanization rate.

Measurement of tan δ (60° C.): each unvulcanized rubber composition was vulcanized at 160° C. for 20 minutes in a mold of 15×15×0.2 cm so as to fabricate a vulcanized rubber sheet. A physical property (tan δ) of these vulcanized rubber sheets was measured according to a test methodology described below. That is, a spectrometer was used to measure tans (initial distortion: 10%; amplitude: ±2%; frequency: 20 Hz; ambient temperature: 60° C.). In Table 1, tan δ is a relative value when a value of Comparative Example 1 is indexed at 100. The larger the index, the more excellent the fuel consumption performance due to a reduced heat buildup.

Measurement of a breaking strength: each unvulcanized rubber composition was vulcanized at 160° C. for 20 minutes in a mold of 15×15×0.2 cm so as to fabricate a vulcanized rubber sheet. A physical property (breaking strength) of these vulcanized rubber sheets was measured using a test methodology described below in accordance with JIS K6251. That is, a No. 3 dumbbell specimen made of each vulcanized rubber sheet was prepared, and the breaking strength was measured under the conditions of temperature: 23° C.; and tensile rate: 500 mm/minute. In Table 1, the breaking strength is a relative value when a value of Comparative Example 1 is indexed at 100. The larger the index, the higher the breaking strength.

Measurement of Payne effect (G′): G′ (0.56%) of each unvulcanized rubber composition was measured using RPA2000 in accordance with ASTM P6204. In Table 1, the Payne effect (G′) is a relative value when a value of Comparative Example 1 is indexed at 100. The larger the index, the higher the dispersibility of silica.

Measurement of wet grip performance: a 235/55R17-sized tire having a tread portion including each rubber composition (of Examples and Comparative Examples) after vulcanization was manufactured. These tires were sequentially attached to an automobile that has an engine size of 2300 cc and has an Antilock Brake System (ABS) being equipped. Air pressures of a front tire and a rear tire were set to 220 kPa, respectively. Then, the automobile was travelled on an asphalt road on which water was sprayed to create a water depth of 2 to 3 mm. A stopping distance required when traveling at a speed of 100 km/hour was measured as the wet grip performance. In Table 1, the wet grip performance is a relative value when a value of the Comparative Example 1 is indexed at 100. The larger the index, the shorter the stopping distance, hence more excellent the wet grip performance.

TABLE 1

| | | | | Comp. | Comp. | Comp. | Comp. | Comp. | Comp. | Comp. | |
|---|---|---|---|---|---|---|---|---|---|---|---|
| | Ex. 1 | Ex. 2 | Ex. 3 | Ex. 1 | Ex. 2 | Ex. 3 | Ex. 4 | Ex. 5 | Ex. 6 | Ex. 7 | Ex. 4 |
| <Blend> | | | | | | | | | | | |
| SBR1 *1 | 85 | — | 55 | — | — | — | 85 | 35 | 85 | — | 85 |
| SBR2 *2 | — | 85 | — | — | — | — | — | — | — | — | — |
| SBR3 *3 | — | — | — | 85 | 85 | 85 | — | 50 | — | — | — |
| SBR4 *4 | — | — | 30 | — | — | — | — | — | — | 85 | — |
| BR *5 | 15 | 15 | 15 | 15 | 15 | 15 | 15 | 15 | 15 | 15 | 15 |
| Specific Silica *6 | 70 | 70 | 70 | — | 70 | 70 | 70 | 70 | 70 | 70 | 80 |
| Comparative Silica *7 | — | — | — | 70 | — | — | — | — | — | — | — |
| Carbon Black *8 | 20 | 20 | 20 | 20 | 20 | 20 | 20 | 20 | 20 | 20 | 10 |
| Mixture A *9 | 3 | 3 | 3 | — | — | 3 | — | 3 | 6 | 3 | 3 |
| Mixture B *10 | — | — | — | 3 | 3 | — | 3 | — | — | — | — |
| Zinc Oxide *11 | 3 | 3 | 3 | 3 | 3 | 3 | 3 | 3 | 3 | 3 | 3 |
| Stearic Acid *12 | 2 | 2 | 2 | 2 | 2 | 2 | 2 | 2 | 2 | 2 | 2 |
| Antioxidant *13 | 2 | 2 | 2 | 2 | 2 | 2 | 2 | 2 | 2 | 2 | 2 |
| Wax *14 | 2 | 2 | 2 | 2 | 2 | 2 | 2 | 2 | 2 | 2 | 2 |
| Silane Coupling Agent *15 | 5.6 | 5.6 | 5.6 | 5.6 | 5.6 | 5.6 | 5.6 | 5.6 | 5.6 | 5.6 | 6.4 |
| Aromatic Oil *16 | 10 | 10 | 10 | 10 | 1.0 | 10 | 10 | 10 | 1.0 | 10 | 10 |
| Sulfur *17 | 1.8 | 1.8 | 1.8 | 1.8 | 1.8 | 1.8 | 1.8 | 1.8 | 1.8 | 1.8 | 1.8 |
| Vulcanizing Accelerator (CBS) *18 | 2 | 2 | 2 | 2 | 2 | 2 | 2 | 2 | 2 | 2 | 2 |
| Vulcanizing Accelerator (DPG) *19 | 0.5 | 0.5 | 0.5 | 0.5 | 0.5 | 0.5 | 0.5 | 0.5 | 0.5 | 0.5 | 0.5 |
| <Physical Property - Characteristic> | | | | | | | | | | | |
| Vulcanization Rate | 104 | 102 | 102 | 100 | 93 | 97 | 94 | 98 | 106 | 96 | 100 |
| Tanδ(60° C.) | 110 | 109 | 108 | 100 | 101 | 103 | 102 | 104 | 101 | 102 | 105 |
| Breaking Strength | 109 | 110 | 107 | 100 | 101 | 102 | 103 | 103 | 99 | 101 | 113 |
| Payne Effect | 106 | 107 | 104 | 100 | 93 | 97 | 95 | 99 | 108 | 95 | 101 |
| WET Grip Performance | 110 | 112 | 108 | 100 | 101 | 103 | 103 | 104 | 102 | 101 | 115 |

*1: SBR1: manufactured by LANXESS K.K. Corporation, BUNA VSL 2438-2 HM (weight-average molecular weight = 1,290,000, styrene content = 41%, and vinyl content = 38%);
*2: SBR2: manufactured by The Dow Chemical Company; product name: SLR6430 (weight-average molecular weight = 1,010,000, styrene content = 41%, and vinyl content = 25%);
*3: SBR3: manufactured by Asahi Kasei Corporation; product name: Tufden 3835 (weight-average molecular weight = 760,000, styrene content = 39%, and vinyl content = 45%);
*4: SBR4: manufactured by Sumitomo Chemical Co., Ltd.; product name: SE6372 (weight-average molecular weight = 1,010,000, styrene content = 34%, and vinyl content = 61%);
*5: BR: manufactured by ZEON CORPORATION, Nipol 1220;
*6: specific silica: manufactured by Rhodia; Zeosil Premium 200MP (nitrogen adsorption specific surface area (N₂SA) = 215 m²/g; CTAB specific surface area = 200 m²/g, DBP absoption = 203 ml/100 g; size distribution width Ld((d84-d16)/d50) = 1.0, V(d5-d50)/V(d5-d100) = 0.71);
*7: comparative silica: manufactured by Rhodia; 1165MP (nitrogen adsorption specific surface area (N₂SA) = 163 m²/g; CTAB specific surface area 159 m²/g, DBP absorption = 202 ml/100 g);
*8: carbon black: manufactured by Cabot Japan K.K.; Shoblack N339;
*9: mixture A: manufactured by Schill & Seilacher GmbH; Struktol HT207 (mixture of fatty acid potassium and fatty acid ester);
*10: mixture B: manufactured by Schill & Seilacher GmbH; product name: EF44 (mixture of fatty acid zinc and fatty acid ester);
*11: zinc oxide: three kinds of zinc oxides manufactured by Seido Chemical Industry Co., Ltd.;
*12: stearic acid: manufactured by NOF Corporation; bead stearic acid NY;
*13: antioxidant: manufactured by Flexsys; Santoflex 6PPD;
*14: wax: manufactured by Ouchi Shinko Chemical Industrial Co., Ltd.; Sunnoc;
*15: Silane coupling agent: manufactured by Evonik Degussa Japan Co., Ltd.; Si69;
*16: aromatic oil: manufactured by Showa Shell Sekiyu K.K.,; Extra No. 4S;
*17: sulfur: manufactured by Tsurumi Chemical Industry Co., Ltd.; Gold Flower brand oil-containing sulfur powder;
*18: vulcanizing accelerator (CBS): manufacture by Flexsys; SANTOCURE CBS;
*19: vulcanizing accelerator (DPG): manufactured by Sumitomo Chemical Co., Ltd.; Soxinol DG

The tire tread rubber compositions of Examples 1 to 4 are formed by blending a specific amount of silica having a specific property and a higher specific surface area and a specific amount of a mixture of a specific fatty acid metal salt and a fatty acid ester with diene rubber containing a specific amount of styrene-butadiene copolymer rubber in which a molecular weight and a styrene content are specified. Thus, as is obvious from the above-described Table 1, in the rubber composition of Examples, a dispersion state of the silica having a higher specific surface area used is good as compared to that of Comparative Example 1, which is the representative conventional example. Moreover, in these Examples, the vulcanization rate is good, and the wet grip performance and the fuel consumption performance are significantly improved.

On the other hand, in Comparative Example 2, similarly to Examples, the specific silica is blended. However, the weight-average molecular weight (760,000) of the blended SBR3 is not in the range between 900,000 and 1,500,000. Further, in Comparative Example 2, the zinc salt is blended as the fatty acid metal salt. Thus, in Comparative Example 2, the dispersibility of the silica deteriorates and the vulcanization rate is slow. As a result, the wet grip performance and the fuel consumption performance were hardly improved.

In Comparative Example 3, similarly to Examples, the specific silica and the mixture of the specific fatty acid metal salt and the fatty acid ester are blended. However, the weight-average molecular weight (760,000) of the blended SBR3 is not in the range between 900,000 and 1,500,000. Thus, in Comparative Example 3, the dispersibility of the silica is insufficient and the vulcanization rate is slow. Thus, a significant improvement was not found either in the wet grip performance or the fuel consumption performance.

In Comparative Example 4, the styrene-butadiene copolymer rubber in which a molecular weight and a styrene content are specified, and the specific silica are blended. However, in Comparative Example 4, the zinc salt is blended as the fatty acid metal salt. Thus, the dispersibility of the silica deteriorates and the vulcanization rate is slow. Thus, a significant improvement was not found either in the wet grip performance or the fuel consumption performance.

In Comparative Example 5, although the SBR1 or specific SBR was blended, the blend amount (35 parts by mass) is less than 40 parts by mass. Thus, in Comparative Example 5, the dispersibility of the silica deteriorates and the vulcanization rate is slow. Thus, a significant improvement was not found either in the wet grip performance or the fuel consumption performance.

In Comparative Example 6, a mass ratio of the mixture of the fatty acid metal salt and the fatty acid ester relative to the specific silica exceeds 8 mass % (about 8.6 mass %). Thus, the breaking strength deteriorates in Comparative Example 6. Thus, a significant improvement was not found either in the wet grip performance or the fuel consumption performance

In Comparative Example 7, the styrene content (34%) of the blended SBR4 is not in the range between 35 to 45%. Thus, the dispersibility of the silica deteriorates and the vulcanization rate is slow. Thus, a significant improvement was not found either in the wet grip performance or the fuel consumption performance.

As described above, in the tire tread rubber composition according to one aspect of the present invention, a specific amount of silica having a specific property and a higher specific surface area and a specific amount of a specific mixture are blended with a specific diene rubber. Further, the specific diene rubber is diene rubber containing a specific amount of styrene-butadiene copolymer rubber having a specific molecular weight and styrene content. Moreover, the specific mixture is a mixture of a fatty acid metal salt and a fatty acid ester. Because the tire tread rubber composition has such a configuration, in spite of the inclusion of the silica of higher specific surface area, the composition has a good dispersion state of silica and a good vulcanization rate. Thus, the tire tread rubber composition excels at a wet grip performance and a fuel consumption performance.

While the invention has been illustrated and described in detail, the foregoing description is in all aspects illustrative and not restrictive. It is therefore understood that numerous modifications and variations can be devised without departing from the spirit and scope of the invention.

What is claimed is:

1. A tire tread rubber composition, comprising:
100 parts by mass of diene rubber;
60 to 110 parts by mass of specific silica; and
a mixture of a fatty acid metal salt (excluding zinc salt) and a fatty acid ester in which a mass ratio relative to the specific silica is 2 to 8 mass %, wherein
the diene rubber contains not less than 40 parts by mass of solution-polymerization styrene-butadiene copolymer rubber,
the solution-polymerization styrene-butadiene copolymer rubber includes a weight-average molecular weight of 900,000 to 1,500,000 and a styrene content of 35 to 45%, and
the specific silica satisfies the following conditions of (1) to (4):
(1) a nitrogen adsorption specific surface area (N₂SA) evaluated in accordance with JIS K6217-2 is 194 to 225 m²/g;
(2) a CTAB specific surface area evaluated in accordance with JIS K6217-3 is 170 to 210 m²/g;
(3) a ratio between the nitrogen adsorption specific surface area (N₂SA) and the CTAB specific surface area (the nitrogen adsorption specific surface area (N₂SA)/the CTAB specific surface area) is 0.9 to 1.4; and
(4) a DBP absorption evaluated in accordance with oil absorption method A of JIS K6217-4 is not less than 190 ml/100 g.

2. The tire tread rubber composition according to claim 1, wherein the vinyl content arising from the butadiene in the solution-polymerization styrene-butadiene copolymer rubber is not more than 45%.

3. The tire tread rubber composition according to claim 1, wherein the diene rubber contains at least one rubber selected from natural rubber, isoprene rubber, butadiene rubber, and acrylonitrile-butadiene copolymer rubber.

4. The tire tread rubber composition according to claim 3, wherein the diene rubber contains butadiene rubber.

5. The tire tread rubber composition according to claim 1, wherein the nitrogen adsorption specific surface area (N₂SA) in the specific silica is 200 to 225 m²/g.

6. The tire tread rubber composition according to claim 1, wherein the CTAB specific surface area in the specific silica is 180 to 210 m²/g.

7. The tire tread rubber composition according to claim 1, wherein the ratio between the nitrogen adsorption specific surface area (N₂SA) and the CTAB specific surface area in the specific silica is 1.0 to 1.3.

8. The tire tread rubber composition according to claim 1, wherein the DBP absorption in the specific silica is 195 to 230 ml/100 g.

9. The tire tread rubber composition according to claim 1, wherein a blend amount of the specific silica is 65 to 100 parts by mass.

10. The tire tread rubber composition according to claim 1, wherein the specific silica has a size distribution width Ld((d84−d16)/d50) of at least 0.91.

11. The tire tread rubber composition according to claim 1, wherein the specific silica has V(d5−d50)/V(d5−d100) of at least 0.66.

12. The tire tread rubber composition according to claim 1, wherein a mass ratio of the mixture of the fatty acid metal salt and the fatty acid ester relative to the specific silica is 3 to 7 mass %.

13. The tire tread rubber composition according to claim 1, wherein the fatty acid used in the mixture of the fatty acid metal salt and the fatty acid ester is a saturated or unsaturated fatty acid with a carbon number of 3 to 30.

14. The tire tread rubber composition according to claim 13, wherein the fatty acid is selected from lauric acid, myristic acid, palmitic acid, stearic acid, oleic acid, and linoleic acid.

15. The tire tread rubber composition according to claim 13, wherein a metal used for forming the fatty acid salt is at least one element selected from K, Ca, Na, Mg, Co, Ni, Ba, Fe, Al, Cu, and Mn.

16. A pneumatic tire comprising the tire tread rubber composition according to claim 1.
